(19) United States
(12) Patent Application Publication
(10) Pub. No.: US 2001/0026370 A1
(43) Pub. Date: Oct. 4, 2001

(54) Image forming apparatus

(76) Inventors: Tetsuo Ogushi, Saga-shi (JP); Yoshihiro Sonoda, Tosu-shi (JP)

Correspondence Address: STEVENS, DAVIS, MILLER & MOSHER, L.L.P., 1615 L Street, N.W., Suite 850, Washington, DC, 20036, US

(21) Appl. No.: 09/810,469

(22) Filed: Mar. 19, 2001

(30) Foreign Application Priority Data
Mar. 24, 2000 (JP) 2000-084319

(51) Int. Cl. B41J 1/00; B41B 1/00; G06F 15/00

(52) U.S. Cl. 358/1.1

(57) ABSTRACT

There is provided an arrangement including a tone processing unit for converting multi-value input data into binary areal tones; a tone pattern table for storing tone patterns to be used by the tone processing unit; a rotating unit for rotating the output of the tone processing unit; a skew compensating unit for compensating for any skew caused by an image forming apparatus upon the output of the rotating unit; a shift point setting unit for setting a skew compensating position; a shifting direction setting unit for setting a shifting direction according to a skew direction; and a rotating direction setting unit for setting a rotating direction, so as to solve the problem that the direction of skew compensation is disrupted due to rotating processing of binary data.

### BACKGROUND OF THE INVENTION

The present invention relates to a technique for correcting the inclination of each individual color image in an electrophotographic color image forming apparatus having a plurality of photosensitive bodies.

In an electrophotographic conventional image forming apparatus, an electrophotographic photosensitive body, serving as an image-carrying member, is charged by a static charger, the charged electrophotographic photosensitive body is irradiated with light in accordance with image information to form a latent image, which is then developed by a developing device, and the developed toner image is transferred to a paper sheet or the like to form the intended image.

On the other hand, as color imaging techniques have become available, there has been proposed a color image forming apparatus having a plurality of image forming stations arranged in tandem, each of which performs the above-cited image forming process to form a cyan image, a magenta image, a yellow image and, preferably, a black image on the respective image-carrying members, and these individual color images are transferred in their respective transfer positions to a paper sheet to form a full color image. Such a color image forming apparatus of the tandem arrangement is advantageous for high-speed operation because it has an image forming section for each individual color.

However, this apparatus involves a problem of difficulty in achieving satisfactory positional registration of the individual images formed by different image forming sections. There arise deviations in the angle of the rotational axis of the electrophotographic photosensitive body drum in each image forming station and in that of the fitting of the scanning optical system, leading to positional misregistrations in oblique directions (hereinafter to be collectively referred to as skews), because positional differences among the formed images of four individual colors transferred to a paper sheet or the like eventually emerge as positional misregistrations or variances in tint. FIGS. 6A and 6B show skewed images, FIG. 6A showing an image skewed upward, and FIG. 6B one skewed downward.

FIG. 7 illustrates a configuration of tone pattern correction according to the prior art.

First, skew compensating means 23 carries out skew compensation, on the basis of a preset quantity of deviation due to skewing, in accordance with shift points given from shift point setting means 24 which sets the shift points of data and a shifting direction from direction setting means 26 which indicates the direction in which the skew has arisen. The procedure of skew compensation will be described below.

FIGS. 8A and 8B are block diagrams of the skew compensating means. It takes out an image from data accumulating means 35 according to the shift points and shift direction, both referred to above, and data correcting means 36 shifts at each shift point in the correcting direction line by line to output an image having no apparent inclination. FIGS. 9A and 9B show skew-compensated images, FIG. 9A showing the result of skew compensation of the image inclined upward to the right, and FIG. 9B, that of skew compensation of the image inclined downward to the right.

However, shifting of the image line by line in the skew compensation procedure invites a new problem of tone disruption. To cope with this problem, tone processing means 34 carries out tone pattern correction by shifting a tone pattern stored in a tone pattern table according to the shift points and shifting direction, both referred to above. This tone pattern correction will be described below.

FIG. 10 illustrates the configuration of tone processing means according to the prior art. Pattern data acquiring means 37 successively takes out pattern data from the tone pattern table 33 in accordance with a table address initial value from table address initial value setting means 28. Binarizing means 32 compares multi-value data and the tone pattern and, if the multi-value data are found greater than the tone pattern, outputs print dots or, if not, outputs binary data as non-print dots. Hereupon, a point counter 30 counts up every time an image is binarized and, when the count becomes identical with a preset shift point offset from shift point offset setting means 29, the counter is reset. The pattern data acquiring means 37 shifts the tone pattern table by one column at a time in a direction reverse to the aforementioned shifting direction, and takes out pattern data. After that, the point counter 30 counts up every time an image is binarized, and resets itself when the count becomes identical with the shift point offset; the pattern data acquiring means 37 shifts the tone pattern table by one column at a time in the direction reverse to the aforementioned shifting direction, and takes out pattern data, resulting in improvement of the tone disruption.

Hereupon, the table address initial value and the shift point offset value in a case where the correcting direction of the tone pattern is upward or downward will be described with reference to FIG. 11. The tone pattern is an image pattern consisting of tile-like segments pasted all over a paper sheet with reference to the origin. Since the print starting position of the image itself is also determined with reference to the origin, the position of the tone pattern in the print starting position is determined on a relative basis. This position of the tone pattern is supposed to be the table address initial value. Since the shift point, too, references the origin, the print starting position and the number of picture elements until the next shift point are determined. This number of picture elements is supposed to be the shift point offset value.

FIG. 12 illustrates the image after the tone pattern correction.

However, in the conventional configuration described above, even if an image forming apparatus which rotates binary data corrects the tone pattern by tone processing, if the image is rotated after that processing and the rotated image undergoes skew compensation, the direction of tone pattern correction will be distorted with respect to the direction of skew compensation with the result that the disruption in tone pattern cannot be remedied.

### SUMMARY OF THE INVENTION

In order to solve the above-mentioned problems, the present invention provides a configuration comprising tone processing means for converting multi-value input data into binary areal tones; a tone pattern table for storing tone patterns to be used by the tone processing means; rotating means for rotating the output of the tone processing means; skew compensating means for compensating for any skew caused by an image forming apparatus upon the output of the rotating means; shift point setting means for setting a skew compensating position; shifting direction setting means for setting a shifting direction according to a skew direction; and rotating direction setting means for setting a rotating direction, wherein the tone pattern can be corrected even if the binary data are rotated. This configuration enables images of high print quality to be obtained by performing appropriate tone pattern correction in advance against the disruption of gradation resulting from the compensation for skews.

### BRIEF DESCRIPTION OF THE DRAWINGS

FIG. 1 shows an arrangement of a color image forming apparatus, which is a first embodiment of the present invention;

FIG. 2 shows an arrangement of the tone pattern correction against rotation in the first embodiment of the present invention;

FIG. 3 shows an arrangement of tone processing means in the first embodiment of the present invention;

FIG. 4 shows an arrangement of a tone pattern table;

FIG. 5 shows a shifting operation of a shiftable tone pattern table in a second embodiment of the present invention;

FIG. 6 shows skewed images;

FIG. 7 shows an arrangement of the tone pattern correction according to the prior art;

FIG. 8 shows a block diagram of skew compensating means;

FIG. 9 shows skew-compensated images;

FIG. 10 shows an arrangement of tone processing means according to the prior art;

FIG. 11 shows a table address initial value and a shift point offset value in a case where the correcting direction of the tone pattern is upward or downward; and

FIG. 12 shows an image after tone pattern correction.

### PREFERRED EMBODIMENTS OF THE INVENTION

(First Embodiment)

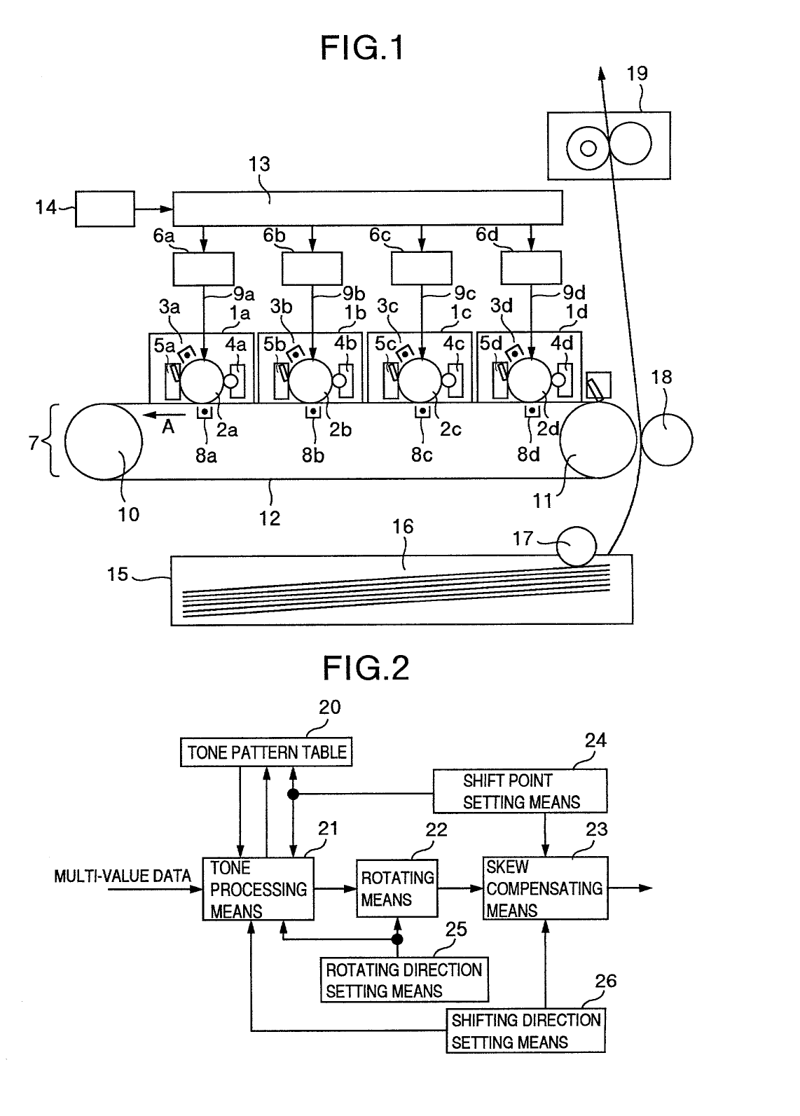

A first embodiment of the present invention will be described below with reference to FIGS. 1 to 4. FIG. 1 shows an arrangement of a color image forming apparatus, which is a first embodiment of the present invention.

First of all, the process of obtaining a color image will be described with reference to FIG. 1.

Referring to FIG. 1, in a color image forming apparatus, there are arranged four image forming stations 1a, 1b, 1c and 1d, and the image forming stations 1a, 1b, 1c and 1d respectively have electrophotographic photosensitive drums 2a, 2b, 2c and 2d as image carrying members, around which there are respectively arranged dedicated charging means 3a, 3b, 3c and 3d, developing means 4a, 4b, 4c and 4d, cleaning means 5a, 5b, 5c and 5d, exposing means 6a, 6b, 6c and 6d of a scanning optical system for irradiating the respective electrophotographic photosensitive drums with light corresponding to image information, and transferers 8a, 8b, 8c and 8d in transferring means 7.

The image forming stations 1a, 1b, 1c and 1d here are where yellow, magenta, cyan and black images are formed, and each light 9a, 9b, 9c and 9d corresponding to the yellow, magenta, cyan and black images are outputted from the exposing means 6a, 6b, 6c and 6d, respectively. In a mode of passing the image forming stations 1a, 1b, 1c and 1d, an intermediate transfer belt 12 of the endless type, supported by rollers 10 and 11, is arranged underneath the electrophotographic photosensitive drum 2a, 2b, 2c and 2d, and moves in a direction of arrow A. The operations of these elements are controlled by control means.

Paper sheets 16 stacked in a paper cassette 15 are fed by a feed roller 17, and discharged into a paper tray (not shown) via a paper sheet transfer roller 18 and fixing means 19.

In the above-mentioned arrangement, after a latent image of the black color component of the image information is first formed on the electrophotographic photosensitive drum 2d by such known electrophotographic processing means as the charging means 3d and the exposing means 6d of the image forming station 1d, it is made visible as a black toner image out of a developer containing a black toner by the developing means 4d, and the black toner image is transferred by the transferer 8d onto the intermediate transfer belt 12.

On the other hand, while the black toner image is being transferred to the intermediate transfer belt 12, the image forming station 1c forms a latent image of the cyan color component, and the developing means 4c provides a cyan toner image out of a cyan toner. The cyan toner image is transferred to the transferer 8c and superposed over the black toner image earlier transferred onto the intermediate transfer belt 12.

Hereafter, a magenta toner image and a yellow toner image are formed by similar methods. When the superposition of the toner images of the four colors on the intermediate transfer belt 12 is completed, the toner images of the four colors are collectively transferred by the paper sheet transfer roller 18 onto the paper sheet 16 fed from the paper cassette 15 by the feed roller 17, and thermally fixed by the fixing means 19 to give a full color image on the paper sheet 16. The electrophotographic photosensitive drum 2a, 2b, 2c and 2d after the completion of the transfer are cleared of the residual toner by the cleaning means 5a, 5b, 5c and 5d to be readied for the next round of image forming, and the printing operation is completed.

While a color image can be obtained in this manner, there arises a misregistration between each image forming station and the scanning optical system, and each color is skewed.

FIG. 2 shows an arrangement of the tone pattern correction against rotation in the fist embodiment of the present invention. The arrangement comprises tone processing means 21 for converting multi-value input data into binary areal tones; a tone pattern table 20 for storing tone patterns to be used by the tone processing means; rotating means 22 for rotating the output of the tone processing means; skew compensating means 23 for compensating for any skew caused by an image forming apparatus upon the output of the rotating means; shift point setting means 24 for setting a skew compensating position; shifting direction setting means 26 for setting a shifting direction according to a skew direction; and rotating direction setting means 25 for setting a rotating direction.

Since each means has its own skew, when each means is assembled and adjusted, the skew is measured according to its output image to assess the quantity of misregistration, and the skew is compensated for by the skew compensating means 23. Further description of this skew compensation is dispensed with, because it is no different from the prior art. Further, as skew compensation gives rise to a disruption in tone pattern attributable to a gap of one line, the tone pattern is corrected in advance by the tone processing means 21.

The tone pattern correction according to the present invention will be described below.

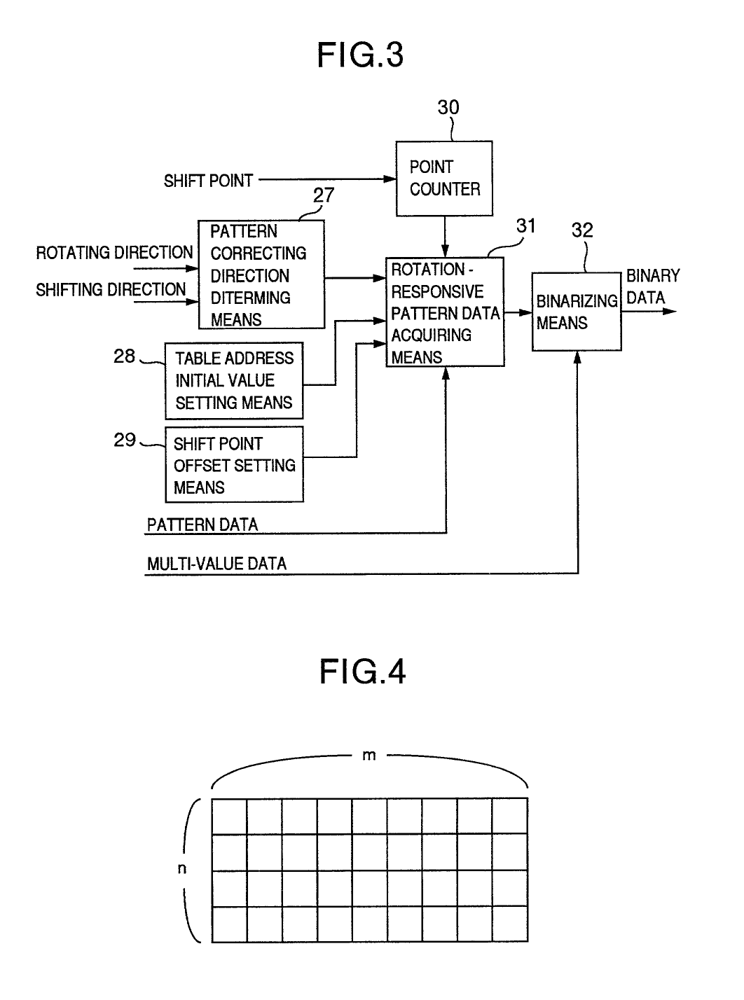

FIG. 3 shows an arrangement of the tone processing means in the first embodiment of the present invention with particular reference to the arrangement of the tone pattern correction. Pattern correcting direction determining means 27 determines in which direction—upward, downward, leftward or rightward—the tone pattern is to be shifted according to the image rotating direction made known by the rotating direction setting means 25 and the shifting direction (upward or downward toward the right) made known by the shifting direction setting means 26. More specifically, where the rotational angle is 0 degree, if the skewing direction is upward toward the right, the direction of tone pattern correction will be downward or, if the skewing direction is downward toward the right, the direction of tone pattern correction will be upward. Where the rotational angle is 90 degrees, if the skewing direction is upward toward the right, the direction of tone pattern correction will be leftward or, if the skewing direction is downward toward the right, the direction of tone pattern correction will be rightward. Where the rotational angle is 180 degrees, if the skewing direction is upward toward the right, the direction of tone pattern correction will be upward or, if the skewing direction is downward toward the right, the direction of tone pattern correction will be downward. Or where the rotational angle is 270 degrees, if the skewing direction is upward toward the right, the direction of tone pattern correction will be rightward or, if the skewing direction is downward toward the right, the direction of tone pattern correction will be leftward.

The tone pattern table 20 stores tone patterns in registers each consisting of an external memory or hardware. In this embodiment, pattern data are supposed to be stored in a block of (rows, columns) =(m, n) as the configuration of the tone pattern table in FIG. 4 shows. Sets of pattern data are usually stored consecutively to facilitate their taking out. Pattern data are taken according to the table address.

Rotation-responsive pattern acquiring means 31 takes out a tone pattern from the tone pattern table 20 on the basis of the direction of tone pattern correction from the pattern correcting direction determining means 27, table address initial values (rows, columns)=(a, b) determined from the printing position of the image on the printing paper and preset in the table address initial value setting means and a shift point offset set in the shift point offset setting means.

For a more specific description, first a case in which the angle of rotation is 90 degrees, the skewing direction is upward toward the right and the direction of tone pattern correction is leftward will be referred to.

As a basic operation, in the processing of the first line of the image, pattern data are taken out of the table address initial values (a, b). Every time a set of pattern data is taken out, only the address value in the column direction is counted up by +1, and sets of data are taken out successively. When the processing has advanced to a point where the address value in the column direction has become equal to m, the address value in the column direction is returned to the beginning to make the table address (0, b). Then, sets of pattern data are again taken out while counting up the address value by +1 each time. This processing is repeated over the whole line.

When the processing of the first line is completed, the second line begins to be processed. The table address then is (a, b+1), with +1 added to the table address initial value in the row direction. Sets of pattern data are taken out while varying the address in the row direction as in the processing of the first line. Processing of the third and subsequent lines will be carried out in the same manner. When the line-by-line processing has advanced to a point where the address in the row direction has become equal to n, the address in the row direction in the table address on the next line is returned to the beginning to reduce the address value in the row direction to 0.

For tone pattern correction, the shift point offset value is set in the processing of the first line as the initial value of the point counter 30. For the second and subsequent lines, the point counter 30 is counted up by +1 every time the processing advances to the next line. When the line-by-line processing has advanced to a point where the count of the point counter has become equal to the shift point value, 1 is subtracted from the address in the column direction of the table address of the line, determined by the above-described basic operation, if the address is not 0 or, if it is 0, the address in the column direction is converted to m. Then, the point counter 30 is cleared at the same time. Similar processing is repeated for the subsequent lines.

Next will be described a case in which the angle of rotation is 90 degrees, the skewing direction is downward toward the right and the direction of tone pattern correction is rightward.

As a basic operation, in the processing of the first line of the image, pattern data are taken out of the table address initial values (a, b). Every time a set of pattern data is taken out, only the address value in the column direction is counted up by +1, and sets of pattern data are taken out successively. When the processing has advanced to a point where has become equal to m, the address value in the column direction is returned to the beginning to make the table address (0, b). Then, sets of pattern data are again taken out while counting up the address value by +1 each time. This processing is repeated-over the whole line.

When the processing of the first line is completed, the second line begins to be processed. The table address then is (a, b+1), with +1 added to the table address initial value in the row direction. Sets of pattern data are taken out while varying the address in the column direction as in the processing of the first line. Processing of the third and subsequent lines will be carried out in the same manner. When the line-by-line processing has advanced to a point where the address in the row direction has become equal to n, the address value in the row direction in the table address on the next line is returned to the beginning to reduce the address value in the row direction to 0.

For tone pattern correction, the shift point offset value is set in the processing of the first line as the initial value of the point counter 30. For the second and subsequent lines, the point counter 30 is counted up by +1 every time the processing advances to the next line. When the line-by-line processing has advanced to a point where the count of the point counter has become equal to the shift point value, +1 is added to the address in the column direction of the table address of the line, determined by the above-described basic operation, if the address is not m or, if it is m, the address in the column direction is converted to 0. Then, the point counter 30 is cleared at the same time. Similar processing is repeated for the subsequent lines.

Next will be described a case in which the angle of rotation is 180 degrees, the skewing direction is upward toward the right and the direction of tone pattern correction is upward.

As a basic operation, in the processing of the first line of the image, pattern data are taken out of the table address initial values (a, b). Every time a set of pattern data is taken out, only the address value in the column direction is counted up by +1, and sets of data are taken out successively. When the processing has advanced to a point where has become equal to m, the address value in the column direction is returned to the beginning to make the table address (0, b). Then, sets of pattern data are again taken out while counting up the address value by +1 each time. This processing is repeated over the whole line.

For tone pattern correction, the shift point offset value is set in the processing of the first line as the initial value of the point counter 30. The point counter 30 is counted up by +1 at every time of image processing in the line direction. When the processing has advanced to a point where the count of the point counter has become equal to the shift point value, 1 is subtracted from the address in the column direction of the table address of the line if the row address, determined by the above-described basic operation, is not 0 or, if it is 0, the address in the row direction is converted to n. Then, the point counter 30 is cleared at the same time. Similar processing is repeated for the subsequent lines.

When the processing of the first line is completed, the second line begins to be processed. The table address then is (a, b+1), with +1 added to the table address initial value in the row direction. Sets of pattern data are taken out while varying the address in the column direction as in the processing of the first line. Processing of the third and subsequent lines will be carried out in the same manner. When the line-by-line processing has advanced to a point where the address in the row direction has become equal to n, the address value in the row direction in the table address on the next line is returned to the beginning to reduce the address value in the row direction to 0.

Next will be described a case in which the angle of rotation is 180 degrees, the skewing direction is downward toward the right and the direction of tone pattern correction is downward.

As a basic operation, in the processing of the first line of the image, pattern data are taken out of the table address initial values (a, b). Every time a set of pattern data is taken out, only the address value in the column direction is counted up by +1, and sets of data are taken out successively. When the processing has advanced to a point where has become equal to m, the address value in the column direction is returned to the beginning to make the table address (0, b). Then, sets of pattern data are again taken out while counting up the address value by +1 each time. This processing is repeated over the whole line.

For tone pattern correction, the shift point offset value is set in the processing of the first line as the initial value of the point counter 30. The point counter 30 is counted up by +1 at every time of image processing in the line direction. When the processing has advanced to a point where the count of the point counter has become equal to the shift point value, +1 is added to the address in the column direction of the table address of the line if the row address, determined by the above-described basic operation, is not n or, if it is n, the address in the row direction is converted to 0. Then, the point counter 30 is cleared at the same time. Similar processing is repeated for the subsequent lines.

When the processing of the first line is completed, the second line begins to be processed. The table address then is (a, b+1), with +1 added to the table address initial value in the row direction. Sets of pattern data are taken out while varying the address in the column direction as in the processing of the first line. Processing of the third and subsequent lines will be carried out in the same manner. When the line-by-line processing has advanced to a point where the address in the row direction has become equal to n, the address value in the row direction in the table address on the next line is returned to the beginning to reduce the address value in the row direction to 0.

Since other combinations of the angle of rotation and the skewing direction fit some case or another of processing so far described, their description is dispensed with.

Pattern data are taken out while varying the table address successively as described above. Each set of pattern data taken out is outputted to the binarizing means 32, and the image is binarized through comparison with its multi-value data.

The binarized image is rotated by the rotating means 22 in a direction of rotation preset by the rotating direction setting means 25, and outputted to the skew compensating means 23. Description of the rotation processing is dispensed with because it is done by a known technique.

(Second Embodiment)

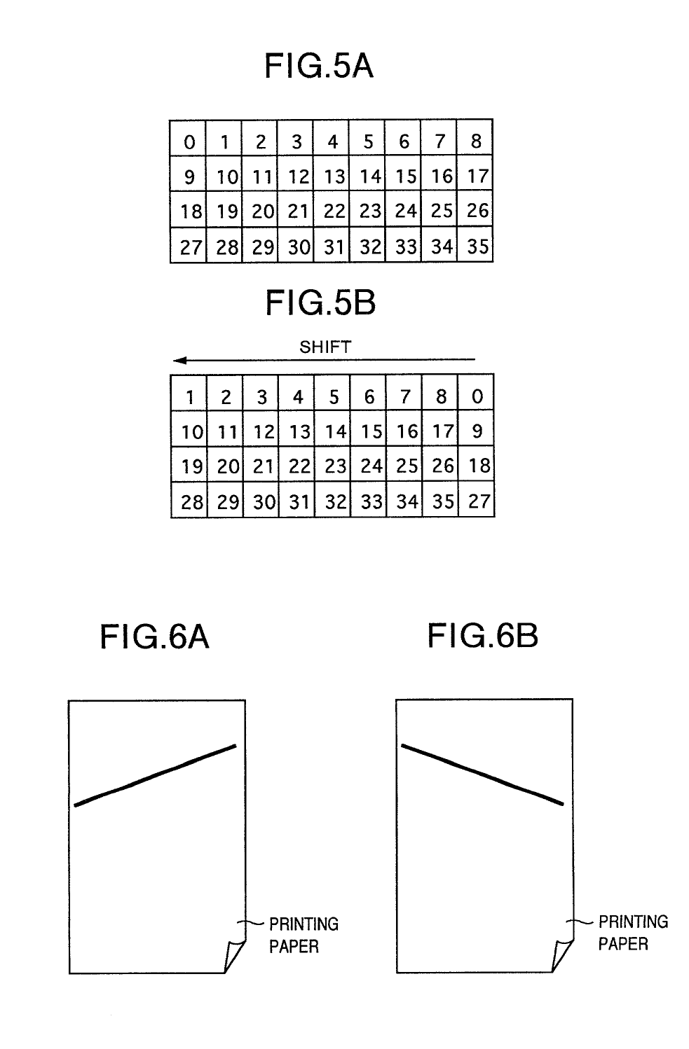

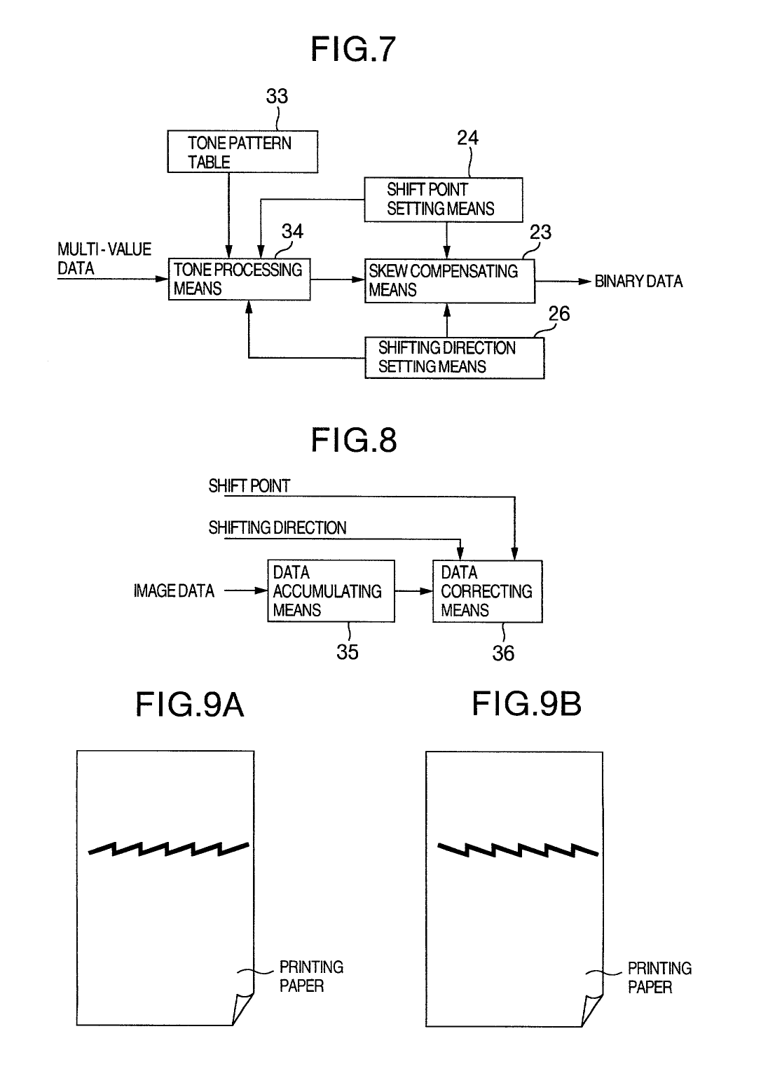

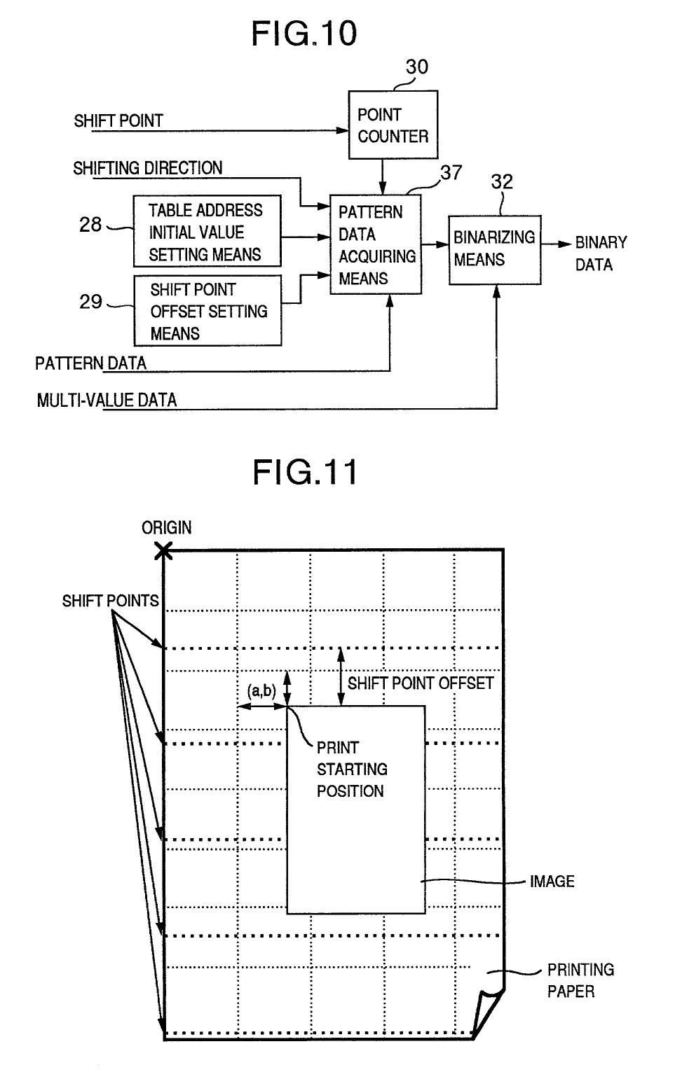

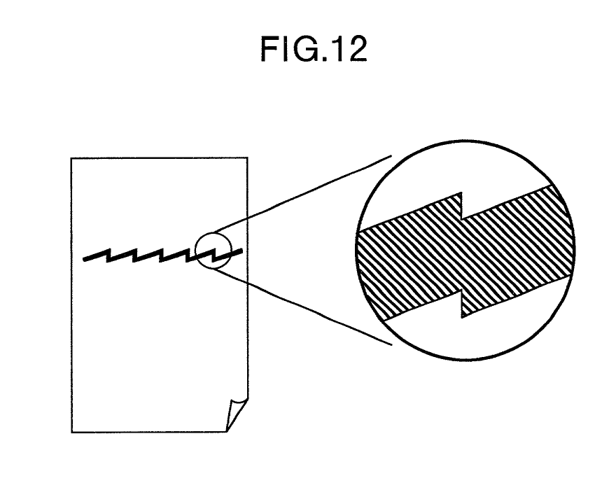

A second embodiment of the present invention will now be described with reference to FIG. 5. FIG. 5 shows a shifting operation of a shiftable tone pattern table in the second embodiment of the present invention. In this second embodiment, the tone pattern table 20 is supposed to be registers of a 6×3 size consisting of hardware. By varying the set point of pattern data according to the direction of tone pattern correction determined by the pattern correcting direction determining means 27, the tone pattern is switched. To be more specific, the processing will be described with reference to a case in which the direction of tone pattern correction is leftward. The pattern is shifted by shifting leftward all the pattern data set in the pattern table, as illustrated in FIG. 5B, when the point counter value has become equal to the shift point value while carrying on processing in the row direction of each line. At this time, pattern data on the leftmost register are stored into the rightmost register. Tone pattern correction in any other direction is accomplished by shifting pattern data. In this processing to shift pattern data, the rotation-responsive pattern acquiring means 31 does not convert any table address by tone pattern correction.

As hitherto described, according to the present invention, it is possible to improve any disruption in tone pattern even if an image is rotated after binarization and subjected to skew compensation, because the disruption due to skew compensation is adjusted in advance with consideration given to the direction of image rotation and that of skew compensation during the binarization. Since no particular alternation in mechanism is required, a color image forming apparatus of high print quality can be achieved with no extra cost.

What is claimed is:

1. An image forming apparatus comprising:
tone processing means for converting multi-value input data into binary areal tones; a tone pattern table for storing tone patterns to be used by said tone processing means;
rotating means for rotating the output of said tone processing means;
skew compensating means for compensating for any skew caused by the image forming apparatus upon the output of said rotating means;
shift point setting means for setting a skew compensating position; shifting direction setting means for setting a shifting direction according to a skew direction; and
rotating direction setting means for setting a rotating direction,
wherein the tone pattern is shifted in the skew compensating position on the basis of information on the shifting direction and the rotating direction.

2. The image forming apparatus according to claim 1, wherein said switching means shifts the tone pattern by controlling a table address at the time of taking out a tone pattern from said tone pattern table.

3. The image forming apparatus according to claim 1, wherein said switching means shifts the tone pattern also by altering a set point of pattern data stored in said tone pattern table.
